(19) United States
(12) Patent Application Publication
(10) Pub. No.: US 2003/0205685 A1
(43) Pub. Date: Nov. 6, 2003

(54) Finite control hydraulic valve

(76) Inventor: Cheol H. Whang, Los Angeles, CA (US)

Correspondence Address: PARK & SUTTON LLP, 3255 WILSHIRE BLVD, SUITE 1110, LOS ANGELES, CA, 90010, US

(21) Appl. No.: 10/074,432

(22) Filed: Feb. 13, 2002

(51) Int. Cl. F16K 5/10

(52) U.S. Cl. 251/209; 251/315.16

(57) ABSTRACT

A valve for a flow control comprises adjacent base tubes each defined by an inner contact and a flow path, and a valve shaft having an outer periphery with first and second sections which symmetrically oppose each other. The valve shaft is holed through the sections to form a channel which is defined by an inner periphery, first and second circumferences each bordering the inner and outer peripheries. Each circumference and section are radially tapered to form grooves each defined by side walls and a hypotenuse bottom. The grooves are diagonal to each other on an imaginary plane along a channel axis.

### BACKGROUND OF INVENTION

The present invention relates to a valve control system. More particularly, the invention relates to an improved valve that precisely manages flow and pressure in a simplified construction.

A valve is used to control a flow amount. As an instance, a valve in a screw type water faucet may control the water flow by controlling its rotation frequency. A pressure control valve, in particular, requires solidarity and durability as well as smooth open-shut operation at high pressure. Other important characteristics for such a valve are sealing and anti-abrasion.

In general, a valve controllably provides a path between adjacent tubes so that a flow such as a hydraulic oil proceeds through the valve path or discontinues depending on an open and shut operation of the valve. The path through the valve is rotatably adjusted to either shut or allow the flow.

A demand for a valve to efficiently control a flow such as hydraulic oil is to enable a path in the valve to become processed such that a precision flow control can be accomplished without requiring parts other than a valve shaft.

### SUMMARY OF THE INVENTION

Accordingly, an object of the present invention is to provide an improved valve for a flow control that precisely manages flow and pressure without requiring an additional part other than conventional requirements. Another object is to enable a path in a valve shaft to additionally serve as a nozzle by forming a groove in each entrance wall of the valve path.

To achieve the above-described objects, a valve for a flow control according to the present invention comprises first and second base tubes adjacent to each other and each defined by an inner contact and a flow path, and a valve shaft having an outer periphery. The outer periphery has a first section and a second section which symmetrically oppose each other. The valve shaft is holed through the first and second sections of the outer periphery to form a channel which is defined by an inner periphery, first and second circumferences each bordering the inner and outer peripheries. Each circumference and section are radially tapered to form a first groove and a second groove each defined by side walls and a hypotenuse bottom. The first groove is formed diagonal to the second groove on an imaginary plane along a channel axis.

For a better performance, each hypotenuse bottom of the first and second grooves is aligned on an extension line right-angled from a valve shaft axis to cross the channel axis. The valve shaft is rotatably inserted between the inner contacts of the first and second base tubes to allow the channel to controllably communicate with each flow path of the first and second tubes in accordance with rotation of the valve shaft. In such a construction, either a flow proceeds from the first flow path through the channel to the second flow path when the channel is communicably aligned with said each flow path of the first and second base tubes, or the flow gradually discontinues by a further rotation of the valve shaft against said each flow path of the first and second base tubes while preventing the flow from stopping at a sudden pace.

The valve may further include valve seats to seal engagement between the valve shaft and the base tubes. The first base tube may be unitary to the second base tube. Each gap between the side walls of the first and second grooves may be even in between about 0.1 mm to about 0.3 mm, preferably in about 0.2 mm. Each gap between the side walls of the first and second grooves may also be on gradual decrease either toward the valve shaft axis toward each hypotenuse bottom of the grooves. Selectively, an angle formed by the channel axis and each hypotenuse bottom may be between about 5 degrees and about 40 degrees, preferably, at about 15 degrees.

Advantages of the present invention are numerous in that: (1) the groove formed in each entrance edge of the channel of the rotatable valve shaft substantially prevents a flow such as a hydraulic oil from making a sudden stoppage as the channel becomes rotatably displaced from alignment with the adjacent tubes, thereby safely finishing a subsequently abrupt operation such as a sudden stop of a vehicle that adopts a hydraulic break system; (2) the groove for further releasing a flow after the channel becomes completely displaced from alignment with the adjacent tubes is easily formed by using, for example, an iron thread without requiring a nozzle, thereby improving efficiency at a relatively low production cost; and (3) a diagonal, diametric alignment of each groove on an imaginary plane along the channel axis allows an easy measurement for the flow amount that passes through each groove, thereby realizing a safety application of the valve to a sophisticated, precision-requiring device such as a hydraulic break system for a vehicle.

Although the present invention is briefly summarized, the fuller understanding of the invention can be obtained by the following drawings, detailed description and appended claims.

### BRIEF DESCRIPTION OF THE DRAWINGS

The above objects and advantages will be more apparent by describing the present invention with reference to the accompanying reference drawings, in which:

FIG. 1 is a construction view of a valve for a flow control according to the present invention in which a channel in a valve shaft is displaced from adjacent tubes to block the flow;

FIG. 2 is another construction view of the valve for a flow control according to the present invention in which the channel in the valve shaft is aligned with adjacent tubes to allow the flow;

FIGS. 3A through 3C are views showing different flow mechanisms relative to rotation of the valve shaft; and

FIGS. 4 and 5 are views showing groove formations according to another embodiment of the present invention.

### DETAILED DESCRIPTION OF THE PREFERRED EMBODIMENTS

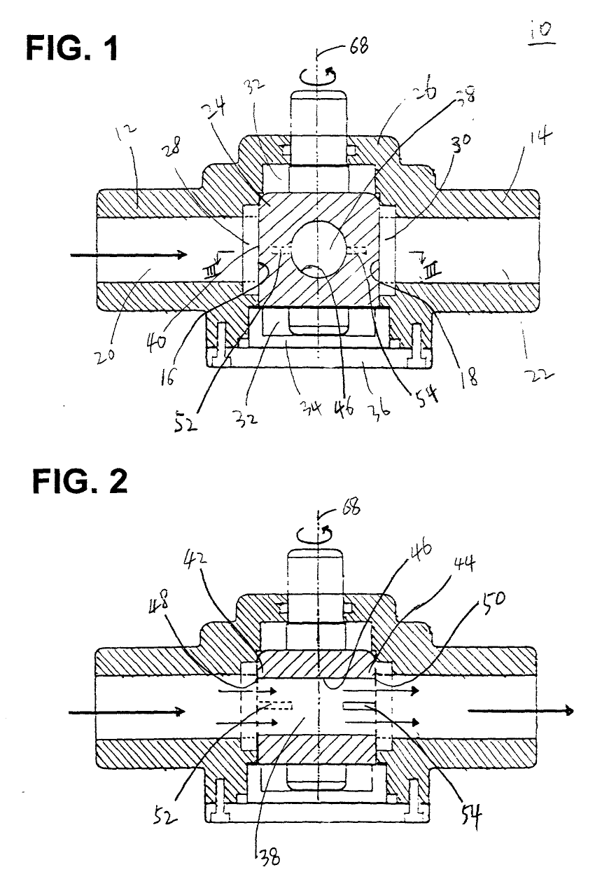

As shown in FIG. 1, a valve 10 for a flow control according to the present invention comprises first and second base tubes 12, 14 adjacent to each other. The first and second base tubes 12, 14 are respectively defined by inner contacts 16, 18 and flow paths 20, 22. A valve shaft 24 is rotatably disposed in a valve body 26 and between the base tubes 12, 14. Valve seats 28, 30 are carried on the inner contacts 16, 18 to seal engagement between the valve shaft 24 and the base tubes 12, 14. In a preferred version, the first base tube 12 is formed unitary to the second base tube 14 when required.

The valve shaft 24 rotates in the valve body 26 with the support of bearings 32. The bearings 32 may be protected by a bearing cap 34 which becomes further protected by a valve cap 36. In this construction, a channel 38 is formed through the valve shaft 24 to either allow or interrupt the passage of a flow such as a hydraulic oil, in accordance with the rotation of the valve shaft 24. That is, FIG. 1 shows a state of flow stoppage by displacement of the channel 38 from the first and second flow paths 20, 22 of the first and second base tubes 12, 14. The valve shaft 24 has an outer periphery 40.

As further shown in FIG. 2, the outer periphery 40 of the valve shaft 24 has a first section 42 and a second section 44 which symmetrically oppose each other. That is, the first section 42 is designated on the opposite side of the second section 44 of the valve shaft outer periphery 24. The valve shaft 24 is holed through the first and second sections 42, 44 of the outer periphery 40 thereof to form the channel 38.

The channel 38 formed through the valve shaft 24 is defined by an inner periphery 46, first and second circumferences 48, 50 each bordering the inner periphery 46 of the channel 38 and the outer periphery 40 of the valve shaft 24. Each entrance circumference 48, 50 of the channel 38 and each section 42, 44 of the valve shaft 24 are radially tapered to form a first groove 52 and a second groove 54.

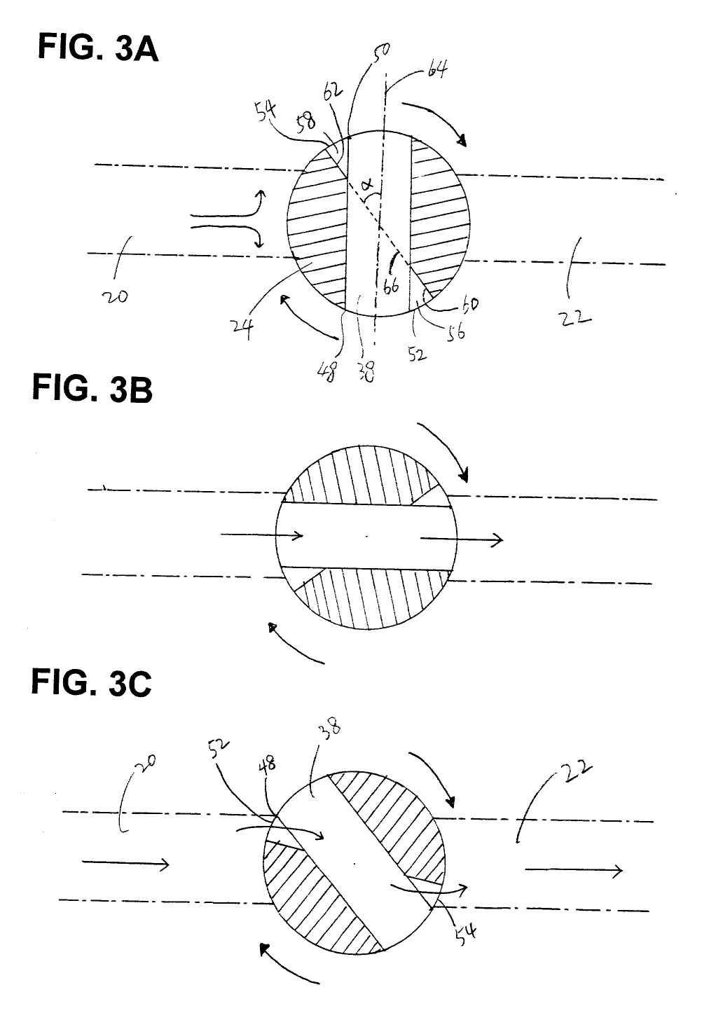

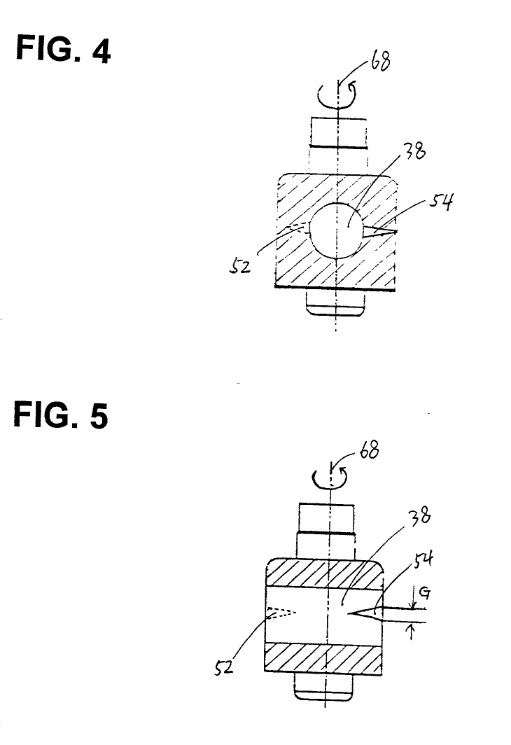

Referring to FIGS. 3A-3C, 4 and 5 in reflection to FIGS. 1 and 2, the first and second grooves 52, 54 are each defined by side walls 56, 58 and a hypotenuse bottom 60, 62. The first groove 52 is formed diagonal to the second groove 54 on an imaginary plane along a channel axis 64. For a better performance, each hypotenuse bottom 60, 62 of the first and second grooves 52, 54 is aligned on an extension line 66 right-angled from a valve shaft axis 68 to cross the channel axis 64.

In this mechanism, the valve shaft 24 is rotatably inserted between the inner contacts 16, 18 of the first and second base tubes 12, 14 to allow the channel 38 to controllably communicate with each flow path 20, 22 of the first and second tubes 12, 14 in accordance with rotation of the valve shaft 24. As a result, when the channel 38 is communicably aligned with each flow path 20, 22 of the first and second base tubes 12, 14 as shown back in FIG. 2 and FIG. 3B, a flow proceeds from the first flow path 20 through the channel 38 to the second flow path 22. Or the flow gradually discontinues by a further rotation of the valve shaft 24 against each flow path 20, 22 of the first and second base tubes 12, 14 while preventing the flow from stopping at a sudden pace in accordance with provision of the first and second grooves 52, 54.

In further detail, when the first circumference 48 of the channel 38 becomes aligned with the first flow path 20 of the first base tube 12, the flow arrow-marked in the drawings begins to stream into the channel 38 and out into the second flow path 22 of the second base tube 14. Subsequently, when the valve shaft 24 makes a further rotation until the first circumference 48 of the channel 38 rotatably passes over the first flow path 20 as shown in FIG. 3C, the channel 38 still receives a slight amount of the flow therein through the first groove 52 and drains the slight flow through the second groove 54 into the second flow path 22, thereby safely relieving an unwanted sudden operation such as a sudden stoppage in its application of a hydraulic break system that adapts a hydraulic oil. Meanwhile, when the valve shaft 42 further rotates so that the grooves 52, 54 become displaced from alignment with the flow paths 20, 22 to allow the flow neither in the channel 38 nor in the grooves 52, 54, a vehicle controlled by such a hydraulic break system makes a complete stoppage.

For a better performance, each groove 52, 54 is formed using an iron thread or an iron string with high stiffness. That is, a selected iron thread is placed through the channel 38 to grind into the first and second circumferences 48, 50 until the hypotenuse bottoms 60, 62 become aligned with the wanted extension line 66. Each gap G between the side walls of each groove 52, 54 is adjustable depending on requirements for flow allowance. That is, the gap G may be formed either even or irregular. In an embodiment for an even gap G between the side walls of each groove 52, 54, each gap G is preferably between about 0.1 mm to about 0.9 mm. The most preferred gap G is about 0.2 mm.

When the gap G is formed irregular, each gap G between the side walls of the first and second grooves 52, 54 is on gradual decrease either toward the valve shaft axis 68 or toward each hypotenuse bottom 60, 62 of the grooves 52, 54. Also, an angle α formed by the channel axis 64 and each hypotenuse bottom 60, 62 is preferably between about 5 degrees and about 40 degrees. The most preferred angle α formed by the channel axis 64 and each hypotenuse bottom 60, 64 is about 15 degrees.

An advantages of the present invention is that the groove 52, 54 formed in each entrance edge of the channel of the rotatable valve shaft 24 substantially prevents a flow such as a hydraulic oil from making a sudden stoppage as the channel becomes rotatably displaced from alignment with the adjacent tubes, thereby safely finishing a subsequently abrupt operation such as a sudden stop of a vehicle that adopts a hydraulic break system.

Further, the groove 52, 54 for further releasing a flow after the channel 38 becomes completely displaced from alignment with the adjacent tubes 12, 14 is easily formed by using, for example, an iron thread without requiring a nozzle, thereby improving efficiency at a relatively low production cost. In addition, a diagonal, diametric alignment of each groove on an imaginary plane along the channel axis 64 allows an easy measurement for the flow amount that passes through each groove, thereby realizing a safety application of the valve 10 to a sophisticated, precision-requiring device such as a hydraulic break system for a vehicle.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is

1. A valve for a flow control, comprising:
a) first and second base tubes adjacent to each other and each defined by an inner contact and a flow path; and
b) a valve shaft having an outer periphery, wherein the outer periphery has a first section and a second section which symmetrically oppose each other, wherein the valve shaft is holed through the first and second sections of the outer periphery to form a channel, wherein the channel is defined by an inner periphery, first and second circumferences each bordering the inner and outer peripheries, wherein said each circumference and section are radially tapered to form a first groove and a second groove each defined by side walls and a hypotenuse bottom, wherein the first groove is formed diagonal to the second groove on an imaginary plane along a channel axis, wherein the valve shaft is rotatably inserted between the inner contacts of the first and second base tubes to allow the channel to controllably communicate with said each flow path of the first and second tubes in accordance with rotation of the valve shaft, whereby either a flow proceeds from the first flow path through the channel to the second flow path when the channel is communicably aligned with said each flow path of the first and second base tubes, or the flow gradually discontinues by a further rotation of the valve shaft against said each flow path of the first and second base tubes while preventing the flow from stopping at a sudden pace.

2. The valve of the claim 1 further comprising valve seats to seal engagement between the valve shaft and the base tubes.

3. The valve of the claim 1 wherein the first base tube is unitary to the second base tube.

4. The valve of the claim 1 wherein each gap between the side walls of the first and second grooves is even.

5. The valve of the claim 4 wherein said each gap between the side walls of the first and second grooves is between about 0.1 mm to about 0.3 mm.

6. The valve of the claim 5 wherein said each gap between the side walls of the first and second grooves is about 0.2 mm.

7. The valve of claim 1 wherein each gap between the side walls of the first and second grooves is on gradual decrease toward the valve shaft axis.

8. The valve of claim 1 wherein each gap between the side walls of the first and second grooves is on gradual decrease toward said each hypotenuse bottom of the grooves.

9. A valve for a flow control, comprising:
a) first and second base tubes adjacent to each other and each defined by an inner contact and a flow path; and
b) a valve shaft having an outer periphery, wherein the outer periphery has a first section and a second section which symmetrically oppose each other, wherein the valve shaft is holed through the first and second sections of the outer periphery to form a channel, wherein the channel is defined by an inner periphery, first and second circumferences each bordering the inner and outer peripheries, wherein said each circumference and section are radially tapered to form a first groove and a second groove each defined by side walls and a hypotenuse bottom, wherein the first groove is formed diagonal to the second groove on an imaginary plane along a channel axis, wherein said each hypotenuse bottom of the first and second grooves is aligned on an extension line right-angled from a valve shaft axis to cross the channel axis, wherein the valve shaft is rotatably inserted between the inner contacts of the first and second base tubes to allow the channel to controllably communicate with said each flow path of the first and second tubes in accordance with rotation of the valve shaft, whereby either a flow proceeds from the first flow path through the channel to the second flow path when the channel is communicably aligned with said each flow path of the first and second base tubes, or the flow gradually discontinues by a further rotation of the valve shaft against said each flow path of the first and second base tubes while preventing the flow from stopping at a sudden pace.

10. The valve of the claim 9 further comprising valve seats to seal engagement between the valve shaft and the base tubes.

11. The valve of the claim 9 wherein the first base tube is unitary to the second base tube.

12. The valve of the claim 9 wherein each gap between the side walls of the first and second grooves is even.

13. The valve of the claim 12 wherein said each gap between the side walls of the first and second grooves is between about 0.1 mm to about 0.3 mm.

14. The valve of the claim 13 wherein said each gap between the side walls of the first and second grooves is about 0.2 mm.

15. The valve of claim 9 wherein each gap between the side walls of the first and second grooves is on gradual decrease toward the valve shaft axis.

16. The valve of claim 9 wherein each gap between the side walls of the first and second grooves is on gradual decrease toward said each hypotenuse bottom of the grooves.

17. The valve of claim 9 wherein an angle formed by the channel axis and said each hypotenuse bottom is between about 5 degrees and about 40 degrees.

18. The valve of claim 17 wherein the angle formed by the channel axis and said each hypotenuse bottom is about 15 degrees.
